(19) United States
(12) Patent Application Publication
(10) Pub. No.: US 2023/0036726 A1
(43) Pub. Date: Feb. 2, 2023

(54) SAMPLE SOLUTION HEATING APPARATUS FOR EX VIVO DIAGNOSIS

(71) Applicant: PRECISION BIOSENSOR INC., Daejeon (KR)

(72) Inventor: Hee Jun KIM, Daejeon (KR)

(21) Appl. No.: 17/789,508

(22) PCT Filed: Sep. 11, 2020
(86) PCT No.: PCT/KR2020/012324

§ 371 Date: Jun. 27, 2022

(30) Foreign Application Priority Data
Dec. 31, 2019 (KR) 10-2019-0179319

(51) Int. Cl. B01L 7/00

(52) U.S. Cl. CPC B01L 7/00; B01L 2300/1811; B01L 2400/043; B01L 2300/12

(57) ABSTRACT

The present disclosure relates to a sample solution heating apparatus for ex vivo diagnosis, and provided is a sample solution heating apparatus for ex vivo diagnosis, the apparatus: injecting a heating body into a reaction container in which a sample solution is stored and induction-heating the heating body by means of a primary induction coil, so as to directly transfer, through the heating body in the sample solution, heat to the sample solution without additional heat transfer media, thereby minimizing heat loss, and thus can rapidly heat the sample solution so as to enable more rapid diagnosis, and can improve energy efficiency; and induction-heating the heating body inside the reaction container and, simultaneously, rotating same by using magnetic force, so as to perform a stirring function, in addition to a simple heating function, on the sample solution, thereby enabling more rapid and accurate ex vivo diagnosis.

### TECHNICAL FIELD

The present disclosure relates to an apparatus for heating sample solution for ex vivo diagnosis. More specifically, the present disclosure relates to an apparatus for heating sample solution for ex vivo diagnosis in which, by inserting a heating body into an inside of a reaction container storing the sample solution and inductively heating the heating body by a first induction coil, the heat can be directly transferred to the sample solution by the heating body in the sample solution without additional heat transfer medium, thereby minimizing the loss of heat and therefore being capable of quickly heating the sample solution and performing diagnosis operation more fast, and also improving energy efficiency, and, by inductively heating the heating body inside the reaction container and rotatingly moving the heating body by using magnetic force at the same time, a function of heating the sample solution as well as an agitation function for the sample solution can be performed, thereby being capable of performing more quickly and accurately performing ex vivo diagnosis.

### BACKGROUND

In recent years, a large amount of micro-information which is poured out as human genome projects have been completed and the post-genome era has arrived cannot be quickly processed by conventional laboratory analysis systems.

Accordingly, biological detection systems for identification of life phenomena, and new drug development and diagnosis are developing in the form of point-of-care testing systems for analyzing samples accurately and conveniently with a smaller amount of the samples in a short time period.

Because most of the biochemical samples to be analyzed exist in a solution state, it is very important to use a technology that allows to instantly test a solution sample at a site and quickly check the result in the point-of-care system.

Recently, in line with the era of prevention and personalized medicine, the ex vivo diagnosis industry has been in the spotlight, such an ex vivo diagnosis industry is a field in which various diseases such as diabetes, cholesterol, cancer, and so can be checked with a drop of blood or urine, and as a part of the point-of-care system, an ex vivo diagnostic device that allows a user to check various diseases at home or while carrying it is being developed.

Such ex vivo diagnostic methods include immunoassays, DNA hybridization, receptor-based analysis, and the like, and these analysis methods are widely used for medical diagnosis or new drug development.

Since the ex vivo diagnostic method is also being developed as a part of the point-of-care testing systems, the technology which allows to instantly test a solution sample at a site and quickly check the result is very important. The solution sample is provided in the form of a sample solution containing a biopsy sample, and various types of reactants inserted into the sample solution may be used depending on the type of the diagnostic method. In order to accurately and quickly diagnose the sample solution for the purpose of maintaining the reaction environment of the biopsy sample and the reactant in the sample solution to be identical to the body environment, generally the sample solution is heated and maintained at a specific temperature for a specific period of time.

As such, in the ex vivo diagnostic method, a heating device for heating a sample solution is almost necessarily used, such a heating device is generally configured to include a heating coil generating heat by receiving power and a heating block surrounding the heating coil, and the sample solution is heated by transferring the heat of the heating block to the sample solution by conduction or radiation or the like.

According to this structure, conventional sample solution heating devices heat the sample solution by conducting or radiating the heat through a separate heating coil and a separate heating block, therefore the efficiency of heat transfer is low and the heating takes a long time, and accordingly there are problems such as making it difficult to quickly diagnose.

### DETAILED DESCRIPTION OF DISCLOSURE

### Technical Problem

To solve the problem of the conventional art, the purpose of the present disclosure may be for providing an apparatus for heating sample solution for ex vivo diagnosis in which, by inserting a heating body into an inside of a reaction container storing the sample solution and inductively heating the heating body by a first induction coil, instead of transferring heat in a way of heat conduction or radiation through an additional heating block, the heat can be directly transferred to the sample solution by the heating body in the sample solution without additional heat transfer medium, thereby minimizing the loss of heat and therefore being capable of quickly heating the sample solution and performing diagnosis operation more fast, and also improving energy efficiency

Another purpose of the present disclosure may be for providing an apparatus for heating sample solution for ex vivo diagnosis in which, by inductively heating the heating body inside the reaction container and rotatingly moving the heating body by using magnetic force at the same time, a function of heating the sample solution as well as an agitation function for the sample solution can be performed and the reaction of diagnosis object material can be properly performed in the sample solution, thereby being capable of performing more quickly and accurately performing ex vivo diagnosis.

### Solution to Problem

The present disclosure may provide an apparatus for heating sample solution, comprising a reaction container formed in a container shape to store the sample solution; a case having an accommodation space therein, wherein an insertion receptacle is formed at one side of the case so that the reaction container is insertable into the insertion receptacle of the case; a first induction coil disposed adjacent to the reaction container and inside the case, the first induction coil configured to induce electromagnetic field by receiving alternating current; and a heating body configured to be insertable into an inner space of the reaction container and configured such that a second current is induced by electromagnetic induction of the first induction coil and the heating body is heated by the induced second current, wherein the heating body is configured to heat the sample solution by induction heat of the heating body.

At that time, the heating body may comprise metal material having conductivity.

Additionally, the heating body may have a structure in which a second induction coil is wound around an outer circumferential surface of a core body.

Further, the heating body may be configured to be inserted into the inner space of the reaction container such that the heat body is freely movable in the inner space of the reaction container.

In addition, a rotation driver configured to rotatingly move the heating body to mix the sample solution stored in the reaction container may be included inside the case.

Additionally, the heating body may have magnetic material, and the rotation driver may be configured to rotatingly move the heating body by magnetic force from an outside of the reaction container.

Further, the rotation driver may comprise a rotation magnet disposed below a lower portion of the reaction container and rotatably mounted inside the case; and a driving motor configured to rotate the rotation magnet, and the heating body may be configured to be rotatingly moved by the magnetic force of the rotation magnet generated by rotation of the rotation magnet.

### Advantageous Effects of Invention

According to the present disclosure, there may be technical effects in that, by inserting a heating body into an inside of a reaction container storing the sample solution and inductively heating the heating body by a first induction coil, instead of transferring heat in a way of heat conduction or radiation through an additional heating block, the heat can be directly transferred to the sample solution by the heating body in the sample solution without additional heat transfer medium, thereby minimizing the loss of heat and therefore being capable of quickly heating the sample solution and performing diagnosis operation more fast, and also improving energy efficiency

Additionally, there may be technical effects in that, by inductively heating the heating body inside the reaction container and rotatingly moving the heating body by using magnetic force at the same time, a function of heating the sample solution as well as an agitation function for the sample solution can be performed and the reaction of diagnosis object material can be properly performed in the sample solution, thereby being capable of performing more quickly and accurately performing ex vivo diagnosis.

### BRIEF DESCRIPTION OF THE DRAWINGS

FIG. 1 is a conceptual view of an entire configuration of an apparatus for heating sample solution for ex vivo diagnosis according to an embodiment of the present disclosure.

FIG. 2 is a figure for illustrating a heating operation of an apparatus for heating sample solution for ex vivo diagnosis according to an embodiment of the present disclosure.

FIG. 3 is a figure for illustrating a mixing structure of an apparatus for heating sample solution for ex vivo diagnosis according to an embodiment of the present disclosure.

### DESCRIPTION OF EMBODIMENTS OF DISCLOSURE

Hereinafter, preferred embodiments of the present disclosure will be described in detail with reference to the accompanying drawings. Throughout this document, reference should be made to the drawings, in which the same reference numerals and symbols will be used to designate the same or like components. Additionally, in the following description of the present disclosure, detailed descriptions of known components and functions incorporated herein will be omitted in the case that the subject matter of the present disclosure may be rendered unclear thereby.

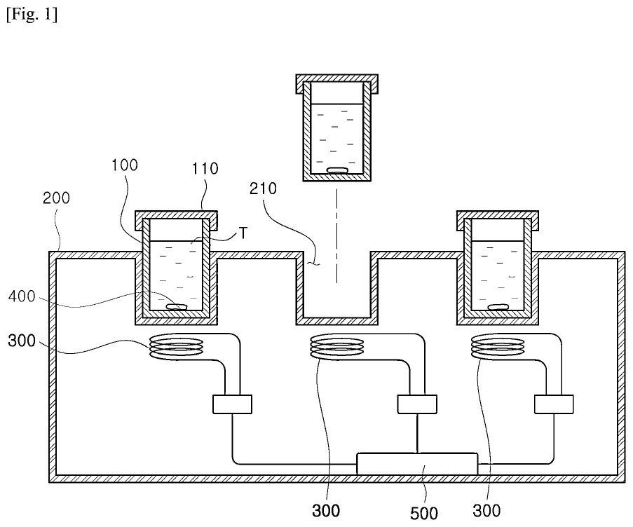

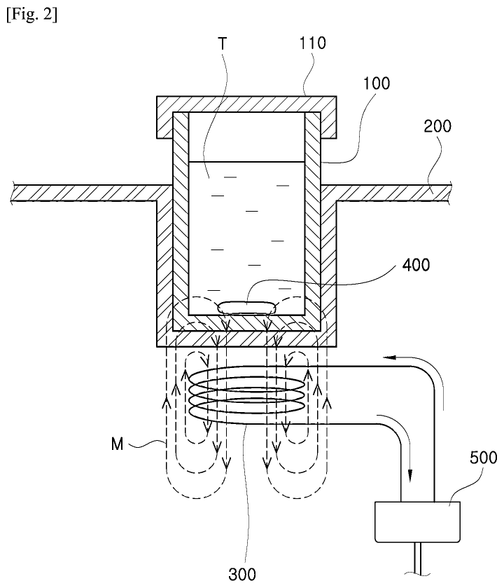

FIG. 1 is a conceptual view of an entire configuration of an apparatus for heating sample solution for ex vivo diagnosis according to an embodiment of the present disclosure, and FIG. 2 is a figure for illustrating a heating operation of an apparatus for heating sample solution for ex vivo diagnosis according to an embodiment of the present disclosure.

An apparatus for heating sample solution for ex vivo diagnosis according to an embodiment of the present disclosure relates to an apparatus of heating sample solution including biological sample or specimen for ex vivo diagnosis by a magnetic induction heating type, and comprises a reaction container (100), a case (200), a first induction coil (300), and a heating body (400).

The reaction container (100) is formed in a container shape to store sample solution (T). For example, the reaction container (100) is formed in a hollow cylinder shape having an opened upper side or portion, and a separate container cover (110) can be coupled to the opened side or portion of the reaction container (100). The reaction container (100) may be made of non-conductive and non-magnetic synthetic resins material.

The case (200) is a configuration forming a basic outer appearance of an entire apparatus, an accommodation space is formed in the case (200) to accommodate various components therein, and an insertion receptacle (or an insertion accommodation unit) 210 is formed at an upper surface of the case (200) so that the reaction container (100) is inserted to and accommodated in the insertion receptacle 210. In some exemplary embodiments, the plurality of the insertion receptacles (210) are formed, and the plurality of the reaction containers (100) are inserted to the plurality of the insertion receptacles (210), respectively, so that each of the reaction containers (100) can be independently heated, respectively.

The first induction coil (300) is disposed adjacent to the reaction container (200) in the case (200) and is configured to induce electromagnetic force when an alternating current is supplied.

The heating body (400) is inserted into an inner space of the reaction container (100) and is configured to induce a second current by the electromagnetic induction of the first induction coil (300) so that the heating body (400) can be heated by the induced second current.

Accordingly, the heating body (400) is inductively heated by the first induction coil (300), and therefore the heat of the heating body (400) is directly transferred to the sample solution (T) to heat the sample solution (T) so that heat transfer is performed without additional heat transfer medium and thus the sample solution (T) can be heated more quickly.

More specifically, the first induction coil (300) is arranged to be positioned below the rejection container (100) and inside the case (200), and is in a winding form having a spiral shape such that alternating power from an alternating power supplier (500) is supplied to the first induction coil (300). When the alternating current is supplied to the first induction coil (300), the direction of current flow is changed according to time flow, and therefore a magnetic field (M) is formed adjacent to the first induction coil (300) as illustrated in FIG. 2. At that time, the direction of magnetic field is changed at the same cycle as the cycle of changing the direction of the current flow of the first induction coil (300). The first induction coil (300) is arranged so that the magnetic field (M) can affect the heating body (400) inserted into the inside of the reaction container (100).

The heating body (400) may be formed in a capsule shape and be made of metal material having conductivity, and is inserted into and freely movable in the inside space of the reaction container (100). The heating body (400) induces the second current according to the change to the magnetic field formed by the first induction coil (300), and provides heat by the induced second current.

The exothermic reaction of the heating body (400) is an exothermic reaction of a magnetic induction type by the first induction coil, and the principle of this exothermic reaction is well known and therefore the detailed description thereof is omitted.

Meanwhile, the heating body (400) is made of material having conductivity for second current induction, and a second induction coil in a wound form is included in the heating body (400). For example, the second induction coil (not shown) can be formed to be wound around a core body (not shown) of non-conductive material (or conductive material) having a capsule shape formed lengthily in one direction.

A process of operation of an apparatus for heating sample solution according to the structure described above will be explained.

Firstly, sample solution (T) is poured into and stored in the reaction container (100), and in this state the reaction container (100) is inserted into the insertion receptacle (210) of the case (200). At that time, the heating body (400) is inserted into the inside of the reaction container (100), and the heating body (400) can be inserted any time before alternating current is supplied to the first induction coil (300). Accordingly, in a state that the heating body (400) is inserted and the reaction container (100) is inserted to the insertion receptacle (210) of the case (200), if the alternating power supplier (500) is activated by manipulation of an operation unit (not shown), alternating current is supplied to the first induction coil (300) and therefore magnetic field is generated as well as changed, second current is induced at the heating body (400) located in the reaction container (100) according to the change in the magnetic field of the first induction coil (300), and the heating body (400) is heated by the induced second current. Because the inductively heated heating body (400) is positioned in the sample solution (T) inside the reaction container (100), the heat of the heating body (400) can be directly transferred to the sample solution (T) thereby quickly heating the sample solution (T).

Accordingly, because an apparatus for heating sample solution for ex vivo diagnosis according to an embodiment of the present disclosure inductively heats the heating body (400), inserted to the inside of the reaction container (100), by the first induction coil (300), it can directly transfer the heat to the sample solution (T) using the heating body (400) without additional heat transfer medium instead of transferring heat through an additional heating block in a heat transfer and radiation type, and therefore the loss of heat can be minimized, through this the sample solution (T) can be quickly heated and diagnosis operation can be performed more quickly, and energy efficiency also can be improved.

Meanwhile, in certain exemplary embodiments, the plurality of the insertion receptacles (210) are formed at the case (200) so that the plurality of the reaction containers (100) can be inserted thereto, and in those embodiments, the first induction coil (300) is arranged below the lower portion of each of the insertion receptacles (210), in a case that a frequency of an alternating power supplied to each of the first induction coils (300) is formed differently to each other, the levels of the induced currents of the heating bodies (400) induced by the first induction coils (300) are different from each other, and because the heating temperature of the heating body (400) is different accordingly, the heating temperature of the sample solution (T) of each of the reaction containers (100) can be adjusted independently by this way. Therefore, more various ex vivo diagnosis can be performed by heating multiple sample solutions (T) at different temperatures simultaneously.

An apparatus for heating sample solution for ex vivo diagnosis according to another embodiment of the present disclosure can be configured to perform agitation function for sample solution so that reaction of diagnosis object material can be properly performed in sample solution in addition to heating function for sample solution.

The agitation function for sample solution can be performed by using the heating body (400), and an agitation structure for sample solution of an apparatus for heating sample solution for ex vivo diagnosis according to an embodiment of the present disclosure will be described below.

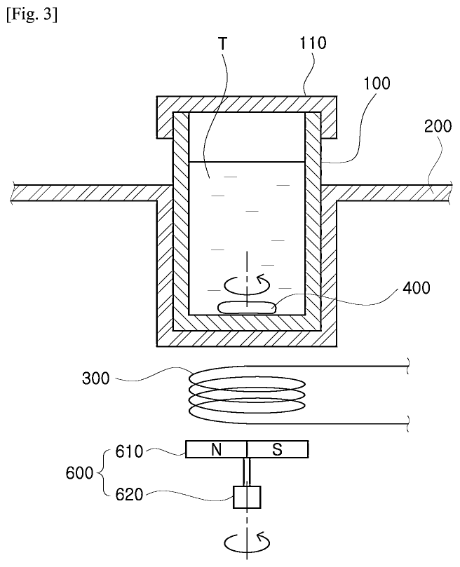

FIG. 3 is a figure for illustrating a mixing structure of an apparatus for heating sample solution for ex vivo diagnosis according to an embodiment of the present disclosure.

An apparatus for heating sample solution for ex vivo diagnosis according to an embodiment of the present disclosure is configured to rotatingly move the heating body (400) to agitate sample solution (T) stored in the reaction container (100), and for this a rotation driving unit (or a rotation driver) 600 configured to rotationally move the heating body (400) is included in the case (200).

At that time, as described above, the heating body (400) is made of metal material of conductive material, and, more specifically, the heating body (400) can be made of magnetic material, and the rotation driving unit (600) is configured to rotatingly move the heating body (400) by magnetic force from the outside of the reaction container (100).

Thus, the rotation driving unit (610) is configured to comprise a rotation magnet (610) rotatably mounted inside the case (200) to be positioned at the lower portion of the reaction container (100), and a driving motor (620) configured to rotate the rotation magnet (610), and is configured to rotatingly move the heating body (400) by the magnet force of the rotation magnet (610) according to the rotation of the rotation magnet (610). Here, the rotation magnet (610) is rotatable by being connected to a rotation axis of the driving motor (620), and the rotation magnet (610) can be formed such that permanent magnet is formed in a structure of being arranged at both sides with respect to the rotation axis.

These configurations of the rotation driving unit (600) are just exemplary embodiments, and various ways such as a type of using electromagnetic force instead of a type of using permanent magnet can be implemented.

According to these configurations, the heating body (400) inserted into the inside of the reaction container (100) can heat the sample solution (T) by being inductively heated by the first induction coil (300) as well as agitate the sample solution (T) by being rotated by the magnet force of the rotation driving unit (600).

Therefore, an apparatus for heating sample solution for ex vivo diagnosis according to an embodiment of the present disclosure can quickly heat the sample solution (T) and can perform agitation at the same time and accordingly ex vivo diagnosis can be performed more quickly and precisely.

The foregoing descriptions have been presented in order to explain certain principles of the present disclosure by way of example, and a person having ordinary skill in the art which the present disclosure relates could make various modifications and variations without departing from the essential features of the present disclosure. Accordingly, the foregoing embodiments disclosed in the present disclosure shall be interpreted as being illustrative, while not being limitative, of the principle and scope of the present disclosure. It should be understood that the scope of the present disclosure shall be defined by the Claims and all of their equivalents fall within the scope of the present disclosure.

What is claimed is:

1. An apparatus for heating sample solution, comprising:
a reaction container formed in a container shape to store the sample solution;
a case having an accommodation space therein, wherein an insertion receptacle is formed at one side of the case so that the reaction container is insertable into the insertion receptacle of the case;
a first induction coil disposed adjacent to the reaction container and inside the case, the first induction coil configured to induce electromagnetic field by receiving alternating current; and
a heating body configured to be insertable into an inner space of the reaction container and configured such that a second current is induced by electromagnetic induction of the first induction coil and the heating body is heated by the induced second current, wherein the heating body is configured to heat the sample solution by induction heat of the heating body.

2. The apparatus for heating the sample solution according to claim 1, wherein the heating body comprises metal material having conductivity.

3. The apparatus for heating the sample solution according to claim 1, wherein the heating body has a structure in which a second induction coil is wound around an outer circumferential surface of a core body.

4. The apparatus for heating the sample solution according to claim 1, wherein the heating body is configured to be inserted into the inner space of the reaction container such that the heat body is freely movable in the inner space of the reaction container.

5. The apparatus for heating the sample solution according to claim 4, wherein a rotation driver configured to rotatingly move the heating body to mix the sample solution stored in the reaction container is included inside the case.

6. The apparatus for heating the sample solution according to claim 5, wherein the heating body has magnetic material, and the rotation driver is configured to rotatingly move the heating body by magnetic force from an outside of the reaction container.

7. The apparatus for heating the sample solution according to claim 6, wherein:
the rotation driver comprises a rotation magnet disposed below a lower portion of the reaction container and rotatably mounted inside the case; and a driving motor configured to rotate the rotation magnet, and
the heating body is rotatingly moved by the magnetic force of the rotation magnet generated by rotation of the rotation magnet.
